(19) United States
(12) Patent Application Publication
(10) Pub. No.: US 2017/0051530 A1
(43) Pub. Date: Feb. 23, 2017

(54) A Self-Contained Deadbolt Sensing Arrangement

(71) Applicant: THOMSON LICENSING, Issy-les-Moulineaux (FR)

(72) Inventors: Gerald A. COLMAN, Indianapolis, IN (US); Girish NAGANATHAN, Fishers, IN (US); Sin Hui CHEAH, Carmel, IN (US)

(21) Appl. No.: 15/307,186

(22) PCT Filed: Apr. 29, 2015
(86) PCT No.: PCT/US2015/028180

§ 371 Date: Oct. 27, 2016

Related U.S. Application Data
(60) Provisional application No. 61/989,564, filed on May 7, 2014.
(60) Provisional application No. 61/989,569, filed on May 7, 2014.

(51) Int. Cl. E05B 17/22; E05B 45/08

(52) U.S. Cl. CPC E05B 17/22; E05B 45/083; E05B 2047/0069

(57) ABSTRACT

A sensor, a wireless transceiver and a battery that energizes the transceiver are installed together in a cavity formed in a frame of a door. They are displaced together in the cavity in accordance with the deadbolt position in a direction of displacement of a door deadbolt. A spring that is installed in the cavity accommodates differences among travel distances and differences in lengths of different deadbolts and also differences in gaps between doors and door frames.

### CROSS REFERENCES

This application claims priority to a U.S. Provisional Application Ser. Nos. 61/989,564, filed on May 7, 2014 and 61/989,569, filed May 7, 2014, which are herein incorporated by reference in its entirety.

### FIELD OF THE INVENTION

The present invention is directed to a system which can monitor the status of a device, in particular, of a deadbolt.

### BACKGROUND OF THE INVENTION

An absentee user of, for example, a building might wish from time to time to indication whether a deadbolt lock is bolted or not. For example, the absentee owner might desire to know, when at home, whether he or she has secured the building for the evening. Without remote monitoring capability, it might be impractical for this person to confirm that the door in fact has been bolted.

An advantageous network arrangement enables a user to securely and remotely query the status of, for example, a property entrance-door deadbolt lock using, for example, a cell phone that can be located substantially anywhere in the world without a need to subscribe to a commercial security service. A remotely situated user using conventional Application software (Apps) for Windows, Android, or iOS is able to receive the status of the deadbolt obtained by detecting when a deadbolt lock is engaged in a door frame or when it is retracted from it based on a queried command. The queried command is applied by wireless communication via a Graphical User Interface installed on a Smartphone or Personal Computer such as a Laptop, Desktop, or Notepad that may be located in the vicinity of the deadbolt lock or at a remote location that may be far from the deadbolt lock.

The deadbolt sensor assembly includes a wireless transceiver/transmitter. Responsive to the sensor output signal, the wireless transceiver/transmitter periodically transmits a first wireless signal conforming to a Bluetooth Low Energy (BLE) protocol that contains deadbolt position information derived from a sensor output signal. A BLE-ZigBee bridge device responsive to the BLE wireless signal periodically stores the deadbolt position information. The bridge device is additionally responsive a second wireless signal conforming to the ZigBee protocol containing a request for the deadbolt position stored information. The bridge device transmits the deadbolt position stored information using a third wireless signal conforming to the ZigBee protocol at a power level that is higher than a power level of the first wireless signal. The third wireless signal may be applied to a gateway device that conveys the deadbolt position information to, for example, a remote user via, for example, a wide area network such as the Internet. It may be desirable to avoid the need to change the appearance of the door and frame for the purpose of installing each of the sensor, wireless transceiver and the battery that energizes the wireless transceiver.

In carrying out an advantageous feature, the sensor, the BLE wireless transceiver and a battery that energizes the BLE wireless transceiver are installed together as a single unit that is inserted into a cavity formed in a frame of a door together. They are also displaced together, during operation, as a single unit in the cavity. A spring, that is also installed in the cavity, advantageously, accommodates differences among travel distances and differences in lengths of corresponding deadbolts and also differences in gaps between doors and door frames.

Advantageously, the deadbolt sensor assembly is displaceable in the cavity and is not firmly attached to any wall of the cavity. An arc-shaped spring of the deadbolt sensor assembly is included for applying a force that hinders the deadbolt sensor assembly from falling out of the cavity when the deadbolt is in an unlock position. This feature leads to a simple installation way that is performed merely by inserting the deadbolt sensor assembly into the cavity that, advantageously, can be performed by substantially untrained user.

Advantageously, reliability of the deadbolt sensing arrangement is improved by informing the user of any malfunction by providing error detection capability that includes redundancy. For obtaining error detection, a plunger switch sensor type senses the position of the deadbolt to generate a first output signal that is indicative when the deadbolt is disposed in the cavity in a lock position and when the deadbolt is disposed outside the cavity in an unlock position. An optical proximity sensor type also senses the position of the deadbolt to generate a second output signal that is indicative when the deadbolt is disposed in the cavity in the lock position and when the deadbolt is disposed outside the cavity in an unlock position. An error detector is responsive to the first and second output signals for detecting an occurrence of an error when the first and second output signals are inconsistent with each other.

Advantageously, a sensor installed in a cavity of a frame of a door is energized by a battery that also energizes a wireless transceiver. The sensor periodically senses a position of a deadbolt. The sensor is responsive to a periodic signal for decreasing a supply current that discharges the battery during a portion of a period of the periodic signal when sensing is disabled. This feature enables the battery to last a long time which is important because it avoids the need for including a battery charging provision in the cavity. Therefore, the need for a frequent service associated with the battery is avoided.

Advantageously, a spring mechanically coupled to the sensor and to the wireless transmitter applies a force when flexed to displace the sensor and the wireless transmitter along an axis of displacement of the deadbolt. The spring is electrically coupled to the wireless transmitter to form an antenna for the wireless transmitter. In this way, the spring provides dual functions. This is accomplished without making any substantial mechanical modifications to the door frame, deadbolt lock, or door. Thus, such arrangement can be made low cost and simple to install.

### SUMMARY OF THE INVENTION

In carrying out an aspect of the advantageous feature, a deadbolt sensor assembly a sensor capable to be disposed in a cavity formed in a frame of a door for sensing a position of a deadbolt to generate an output signal that is indicative when the deadbolt position is in the cavity in a lock position and when the deadbolt position is disposed outside the cavity in an unlock position. A wireless transmitter responsive to the sensor output signal and capable of being disposed in the cavity is used for transmitting a wireless signal containing information derived from the output signal. The sensor and the wireless transmitter are mechanically coupled to each other and are capable of being displaced together in the cavity in accordance with the deadbolt position.

### BRIEF DESCRIPTION OF THE DRAWINGS

FIG. 1A illustrates a deadbolt sensor assembly, embodying an advantageous feature, as installed in a doorjamb;

FIG. 1B illustrates a side view of the sensor assembly of FIG. 1A when separated from the door jamb;

FIG. 1C illustrates a front view of the sensor assembly of FIG. 1B;

FIG. 2 illustrates a circuit diagram of the sensor assembly of FIG. 1A;

FIGS. 3a, 3b and 3c illustrate corresponding flow charts associated with the sensor assembly of FIG. 1A;

FIG. 4 illustrates a block diagram of a communication network that includes the sensor assembly of FIG. 1A; and

FIG. 5 illustrates a block diagram of a home-automation network forming an expansion of the communication network of FIG. 4.

### DETAILED DESCRIPTION

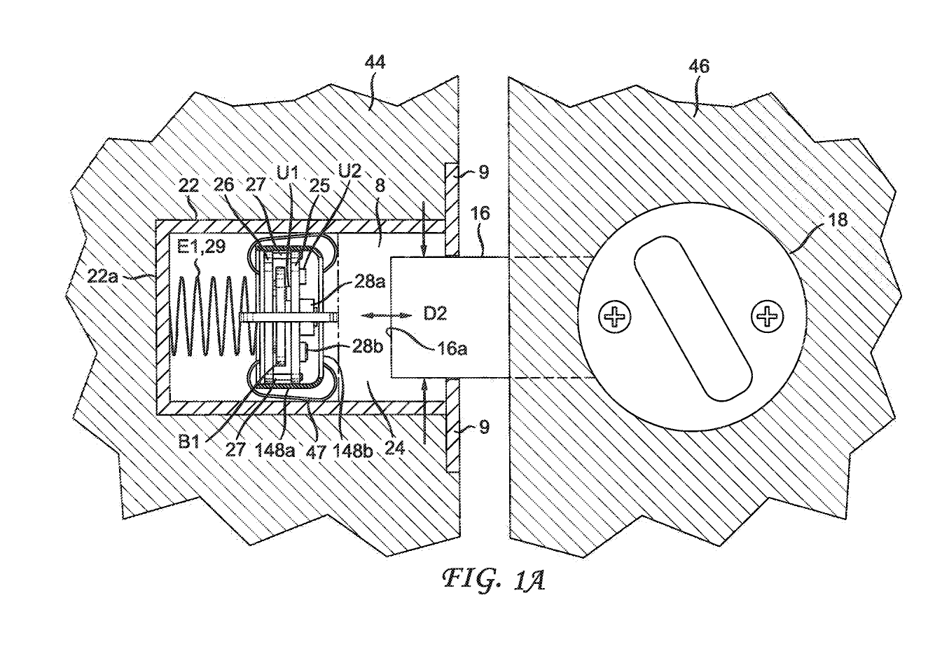

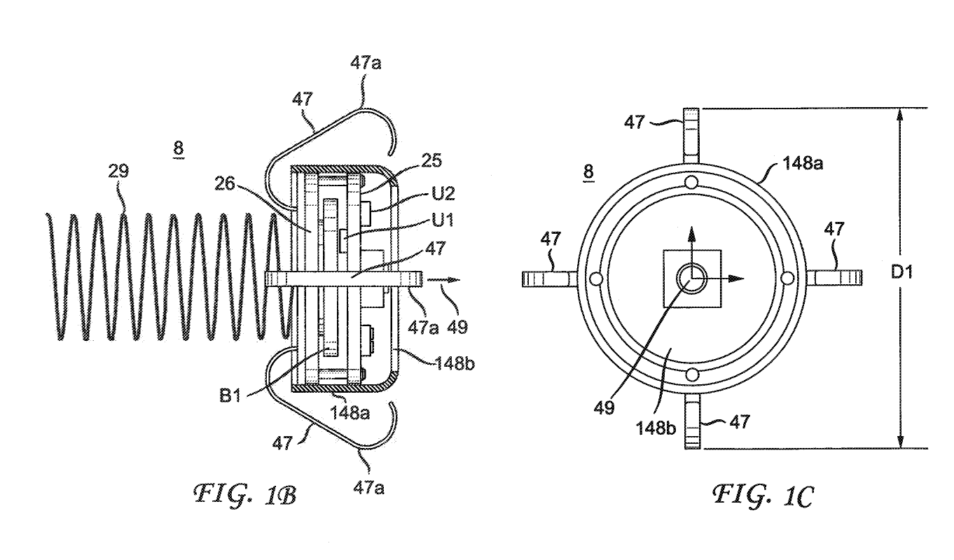

FIG. 1A illustrates a sensor assembly 8, embodying an advantageous feature, for use with a deadbolt 16 forming a lock in a door 46. A housing 22 defining a deadbolt cavity 24 in a door jamb or frame 44 receives deadbolt 16, when deadbolt 16 is locked. Sensor assembly 8 is also received in cavity 24. However, instead of installing housing 22 for forming cavity 24, door jamb 44 may be drilled out to form cavity 24. For example, it can be drilled out with ⅞ inch to 1 inch diameter spade to a depth of between 1 and ¼ inch to 1 and ½ inch. A diameter D2 of cavity 24 may range from ⅞ inch to 1 inch.

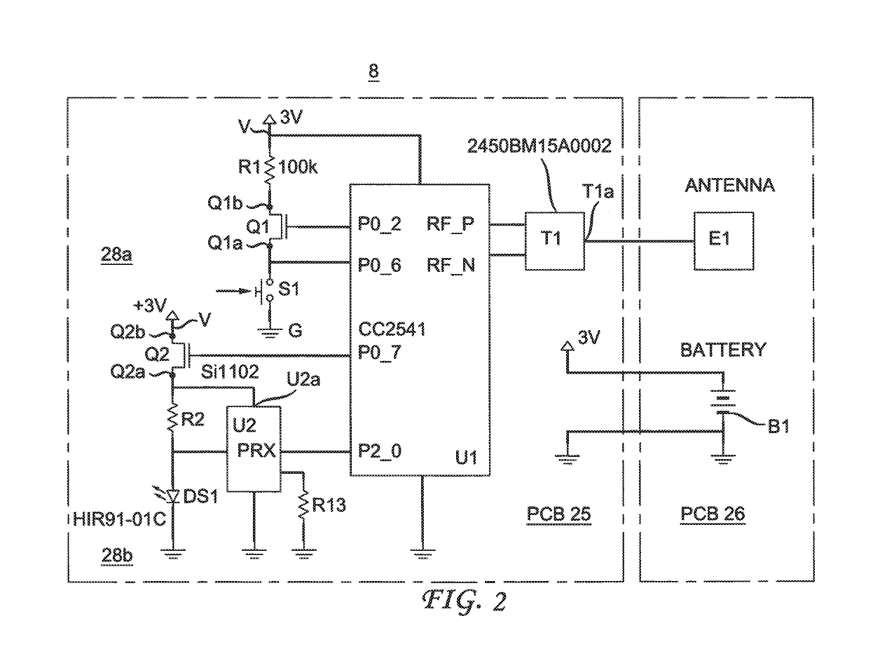

Sensor assembly 8 includes a pair of sensors 28a and 28b shown in an electrical circuit diagram of FIG. 2. Similar symbols and numerals in FIGS. 1A and 2 indicate similar items or functions. Sensor 28a of FIG. 2 includes a mechanically operated plunger switch S1. Plunger switch S1 of sensor 28a of FIG. 1A is not depressed when deadbolt 16 is dis-engaged for unlocking door 46. When switch S1 of FIG. 2 is not depressed, switch S1 forms a non-conductive or open circuit. Conversely, plunger switch S1 of sensor 28a of FIG. 1A is depressed when deadbolt 16 is engaged for locking door 46. When switch S1 of FIG. 2 is depressed, a current path is formed between its terminals.

A field effect transistor (FET) Q1 of FIG. 2 has a first main current conducting terminal Q1a that is coupled to a corresponding terminal of switch S1 and a second main current conducting terminal Q1b that is coupled via a pull-up resistor R1 to a supply voltage V provided by a lithium coin battery B1, Energizer CR 1220. The other terminal of switch S1 is coupled to a ground terminal G at 0V. Battery B1 has a nominal voltage of 3.0 volts.

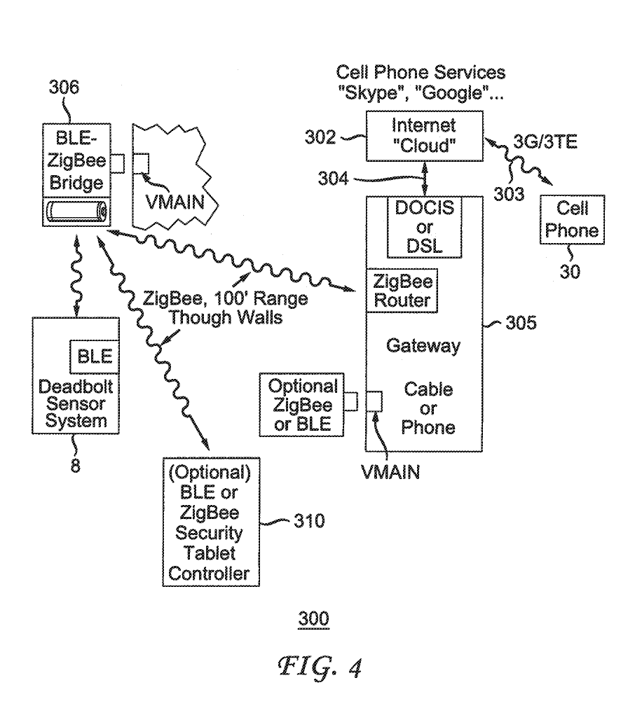

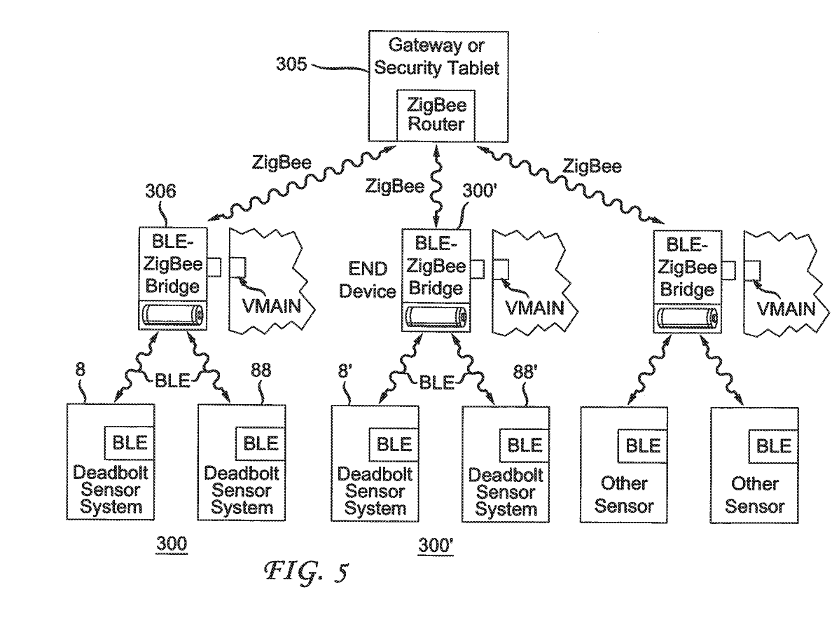

A System on Chip (SOC) U1, such as Texas Instruments CC2541 contains a processor and a 2.4 GHz Bluetooth low energy (BLE) transmitter-receiver or transceiver, which are not shown in details. BLE is a wireless personal area network technology. SOC U1 polls, in response to the periodic command, a port P0_6 of SOC U1. The period or frequency in which SOC U1 performs the polling operation is controlled, under normal operation conditions, by a BLE-ZigBee bridge device 306 of FIGS. 4 and 5 that is referred to later on. Polling is accompanied in SOC U1 of FIG. 2 by applying a control voltage via a port P0_2 to a gate terminal of FET Q1 to turn on FET Q1. When turned on, FET Q1 couples pull-up resistor R1 to port P0_6. When switch S1 is depressed, switch S1 couples port P0_6 of SOC U1 to ground terminal G. Consequently, a voltage at 0V is sensed at port P0_6 when SOC U1 polls port P0_6. The voltage at 0V, sensed at port P0_6 by the processor of SOC U1, is indicative of deadbolt 16 of FIG. 1A being engaged to lock door 46.

Advantageously, FET Q1 of FIG. 2 is turned on to activate detection of the status of switch S1 only, during periodic intervals, when the aforementioned polling occurs. At other times FET Q1 is turned off. This mode of operation is utilized in order to reduce discharge or depletion of battery B1. This feature is particularly important because battery B1 is not connected to any battery charger. Yet, battery B1 is required to serve for a long time without a need for frequent replacement service. If switch S1 was turned on as long as deadbolt 16 is engaged, there would have been an undesirable constant draw of approximately 30 micro-amps from battery B1 via resistor R1.

As indicated before, switch S1 is not depressed when deadbolt 16 of FIG. 1A is disengaged for unlocking door 46. When not depressed, switch S1 of FIG. 2 is non-conductive. Therefore, FET Q1 couples port P0_6 to battery B1 voltage V of 3V via pull-up resistor R1. Thus, SOC U1 sensing the presence of battery B1 voltage V at port P0_6 is indicative of deadbolt 16 of FIG. 1A being disengaged to unlock door 46.

Advantageously, redundant sensor 28b utilizes an infra-red (IR) proximity detector U2. Sensor 28b facilitates error detection feature. An FET Q2 of FIG. 2 has a first main current conducting terminal Q2a that is coupled both to a supply terminal U2a of proximity detector U2 and to a current limiting resistor R2. A second main current conducting terminal Q2b of FET Q2 is coupled to supply voltage V of battery B1. SOC U1 applies a voltage to a port P0_7 that is coupled to a gate terminal of FET Q2 to turn on FET Q2 for performing polling operation in proximity detector U2. Similarly to FET Q1, FET Q2 is turned on to activate the detection associated with proximity detector U2 only when the aforementioned polling occurs in sensor 28b. At other times, FET Q2 is turned off. This mode of operation that is similar to that applicable to FET Q1 is utilized in order to reduce discharging battery B1.

Optical proximity detector U2 of the type Silicon Labs Si1102 operates in cooperation with an IR light emitting diode (LED) DS1 of a type, Everlight HIR91-01C. LED DS1 is driven via current limiting resistor R2 by FET Q2, when FET Q2 is turned on for polling an output signal PRX of detector U2.

Optical proximity detector U2 is an active optical reflectance proximity detector with an on/off digital output whose state is based upon the comparison of reflected IR light against a set threshold. LED DS1 produces light pulses at a strobe frequency of 2.0 Hz of which reflections from a front face 16a of deadbolt 16 of FIG. 1A reach a photodiode, not shown, of proximity detector U2 of FIG. 2 and are processed by proximity detector U2 analog circuitry, not shown. The rate detector U2 detects proximity of deadbolt 16 of FIG. 1A is controlled by a resistor R13 of FIG. 2. The average current drawn by detector U2 is 5 micro-amps with proximity detection frequency of 2.0 Hz. A resulting most recent or current state of the detected proximity is developed at output signal PRX of detector U2 that is polled by port P2_0 of SOC U1. If the reflected light is above the detection threshold, proximity detector U2 asserts an active-LOW output signal PRX to indicate that dead-lock 16 of FIG. 1A is locked. Conversely, if the reflected light is below the detection threshold, proximity detector U2 of FIG. 2 asserts a HIGH output signal PRX to indicate that deadbolt 16 of FIG. 1A is unlocked.

A pair of terminals RF_P and RF_N of SOC U1 communicate Radio Frequency (RF) modulated signal transmitted/received by the BLE transceiver, not shown, of SOC U1 in accordance with the BLE protocol. Terminals RF_P and RF_N of SOC U1 are coupled to corresponding pair of terminals, respectively, of an Impedance Matched RF Front End Differential Balun-Low Pass Filter integrated passive component T1. Component T1 is made by Johanson Technology, Inc, part number 2450BM15A0002. An output terminal of integrated passive component T1 is coupled to an antenna E1 for transmitting/receiving the RF signal associated with the BLE transceiver of SOC U1.

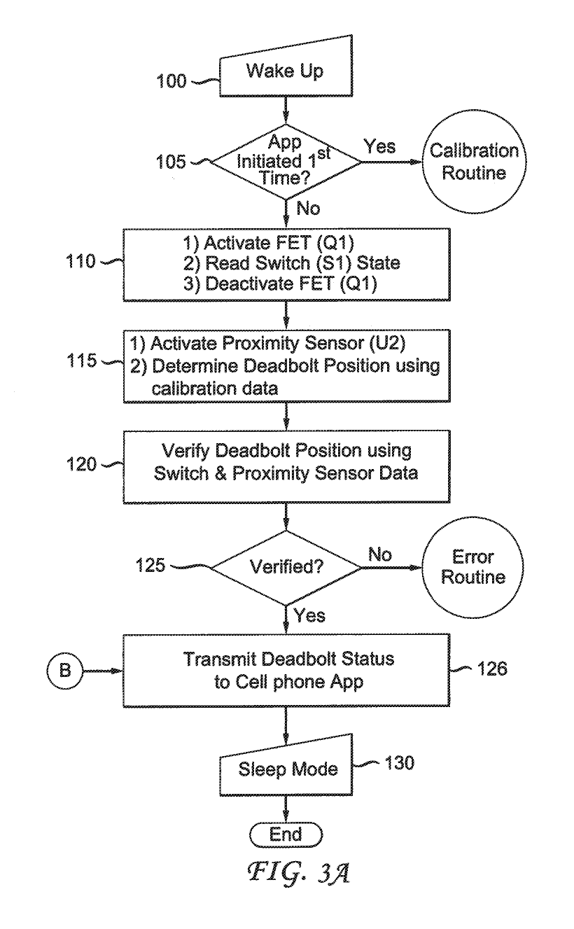

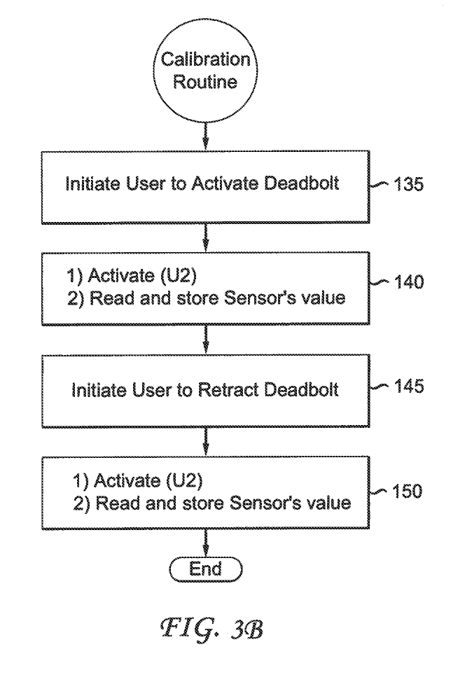

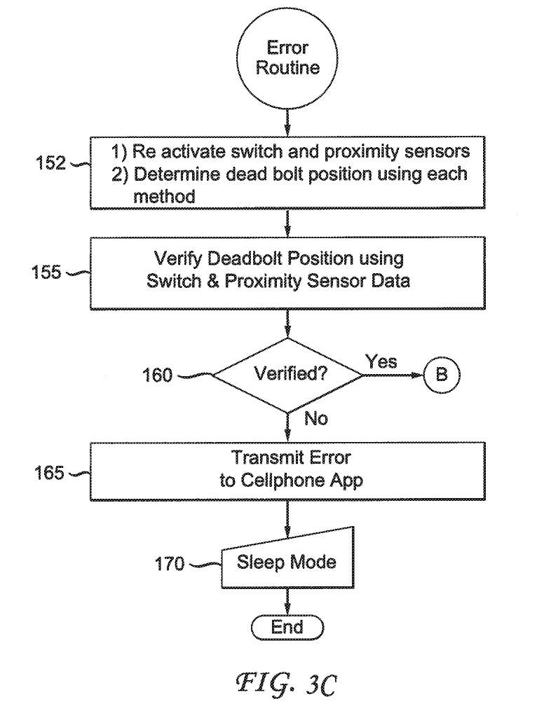

FIGS. 3a, 3b and 3c provide flow charts useful for explaining the operation of sensor assembly 8 of FIGS. 1A and 2. Similar symbols and numerals in FIGS. 1A-2, 3a, 3b and 3c indicate similar items or functions. Except otherwise noted, sensor assembly 8 of FIGS. 1A and 2 participate in each step referred to in FIGS. 3a, 3b and 3c.

Under normal operation, a periodic command referred to in more details later on, may be transmitted using BLE wireless signal initiated, for example, in BLE-ZigBee bridge device 306 of FIG. 4, which is also referred to later on, and received by the BLE transceiver of SOC U1 of FIG. 2. Upon the occurrence of the aforementioned periodic command, SOC U1, operating in a so-called Sleep Mode prior to the occurrence of the aforementioned periodic command, performs a so-called Wake Up step 100 of the flow chart of FIG. 3a. Next, SOC U1 of FIG. 2 tests in a step 105 of FIG. 3a whether SOC U1 of FIG. 2 has been initiated for the first time. If it has been initiated before, then SOC U1, in a step 110 of FIG. 3a, turns on or activates FET Q1 of FIG. 2 for activating status checking of deadbolt 16 of FIG. 1A, as explained before, by SOC U1 polling port P0_6 that reads the state of switch S1. After polling port P0_6, SOC U1 deactivates FET Q1, as explained before.

Next, SOC U1, in a step 115 of FIG. 3a, turns on or activates FET Q2 of FIG. 2 for checking the status of proximity detector U2 by reading output signal PRX developed at port P2_0. Subsequently, in a step 120 of FIG. 3a, the reading of proximity detector U2 output signal PRX of FIG. 2 is compared in the processor, not shown, of SOC U1 with the reading of the previously obtained state of switch S1 for providing error checking that is performed in a processor, not shown, of SOC U1. If the readings are consistent or verified, in a step 125 of FIG. 3a, then, in a step 126 that is performed by BLE-ZigBee bridge device 306 of FIGS. 4 and 5 that is referred to later on, the state of deadbolt 16 of FIG. 1A, locked or unlocked, is transmitted. Afterwards, in a step 130 of FIG. 3a, SOC U1 of FIG. 2 returns to the so-called Sleep Mode.

If at step 105 of FIG. 3a it is determined that SOC U1 of FIG. 2 has been initiated for the first time, BLE-ZigBee bridge device 306 that is referred to later on of FIGS. 4 and 5 transmits a message, in a step 135 of a calibration routine of FIG. 3b, requesting the user to activate deadbolt assembly 8 of FIG. 1A. Activation of deadbolt assembly 8 is performed by changing its current state, lock or unlock, to the other state. Then, SOC U1 of FIG. 2 in a step 140 of FIG. 3b polls each of port P0_6 and port P2_0 of FIG. 2 and stores the state of each of switch S1 and IR detector U2. Next, in a step 145 of FIG. 3b, SOC U1 transmits a message to a user located next to deadbolt 16 of FIG. 1A requesting the user to change the state of deadbolt 16 from its preceding locked or unlocked state to the opposite state. Following the changing of the state of deadbolt 16, SOC U1 of FIG. 2, in a step 150 of FIG. 3b, polls each of port P0_6 and port P2_0 of FIG. 2 and stores the state of each of switch S1 and IR detector U2. This calibration process is used to confirm that each switch S1 and proximity detector U2 do indeed change state in response to the change of state of deadbolt 16.

If the processor, not shown, in SOC U1 of FIG. 2, at step 125 of FIG. 3a, determines that error has occurred, SOC U1 initiates an error routine of FIG. 3c. In a step 152, SOC U2 of FIG. 2 reactivates FET Q1 for reading at port P0_6 the state of switch S1 and reactivates FET Q2 of FIG. 2 for reading the status of proximity detector U2 by reading output signal PRX at port P2_0. Next, in a step 155 of FIG. 3c, the reading of proximity detector output signal PRX of FIG. 2 is compared to the reading of the state of switch S1. If the readings are consistent or verified, in a step 160 of FIG. 3c, then step 126 of FIG. 3a follows. Otherwise, BLE-ZigBee bridge device 306 that is referred to later on of FIGS. 4 and 5 transmits an error message in a step 165 of FIG. 3. Next, in a step 170 of FIG. 3c, SOC U1 of FIG. 2 returns to the so-called Sleep Mode.

Other than antenna E1 and battery B1 of FIG. 2, the rest of the circuitry of sensor assembly 8 that is depicted in FIG. 2 is mounted on a first printed circuit board (PCB) 25 of FIG. 1A. Battery B1 is mounted on a second PCB 26 that is connected to PCB 25 using pin standoffs 27. PCB 25, PCB 26 and pin standoffs 27 are contained in an enclosure 148a to form a structure having a length dimension, measured in the direction of the movement of deadbolt 16, of approximately ⅓ inch. Enclosure 148a has an opening 148b for enabling deadbolt 16 to contact plunger switch S1 of FIG. 2 of sensor 28a of FIG. 1A when deadbolt 16 is engaged for locking door 46.

A spring 29 has an end portion, remote from PCB 26, which makes a sliding contact, without being fastened or immobilized, to a back wall 22a of housing 22. Spring 29 has an opposite end that is mechanically attached to PCB 26. Thus, spring 29 is interposed between sensor assembly 8 and back plate 22a. As explained later on, during installation, spring 29 and the structure of PCB 25, PCB 26 and pin standoffs 27 are manually pushed into cavity 24 to remain there indefinitely.

Deadbolt 16 should, preferably, have sufficient clearance relative to plunger switch S1 of FIG. 2 so as not to contact switch S1 when deadbolt 16 of FIG. 1A is unlocked. Also, deadbolt 16, preferably, should be able to contact plunger switch S1 of FIG. 2 without causing spring 29 of FIG. 1A to be fully compressed when deadbolt 16 is locked.

In carrying out an advantageous feature, battery B1 of FIG. 2, switch S1, detector U2 and SOC U1 are disposed on the structure formed by PCB 25 and PCB 26 that is connected to spring 29. Interposing spring 29 between wall 22a of housing 22 and the structure formed by PCB 25, PCB 26 and standoffs 27, advantageously, provides a capability to displace together battery B1, switch S1, detector U2 and SOC U1 that are entirely contained in cavity 24 of FIG. 1A. Displacing together battery B1, switch S1, detector U2 and SOC U1 of FIG. 1A is caused by the movement of deadbolt 16. The flexing capability of spring 29 compensates for a particular travel distance selected for deadbolt 16, a particular selected length of deadbolt 16 and a particular gap selected between door 46 and frame 44. The compensation is obtained by different extent of compression/expansion of spring 29 when deadbolt 16 is moved from the unlock position to the lock position, and vice versa.

In carrying out another advantageous feature, the ability of PCB 25, PCB 26 and pin standoffs 27 to move together laterally in response to locking/unlocking deadbolt 16 by the operation of spring 29 avoids the need to adjust the position of sensor assembly 8, during installation in door frame 44. This feature makes sensor assembly 8 versatile for accommodating differences among travel distances and differences in lengths of different deadbolts similar to deadbolt 16 and also differences of corresponding gaps between variety of door and door frame combinations such as between door 46 and door frame 44.

In carrying out a further advantageous feature, packaging battery B1, Balun-Low Pass Filter integrated passive component T, SOC U1, IR detector U2 and switch S1 on the structure formed by PCB 25, PCB 26 and pin standoffs 27 avoids the need for installing any part of moveable sensor assembly 8 externally to cavity 24. Additionally, sensor assembly 8 can be manufactured in sizes to accommodate common industry standards. Thus, sensor assembly 8 and housing 22 require minimal or no modification of pre-existing combinations of door frame, door and deadbolt.

Advantageously, in addition to the spring action of spring 29, spring 29 may also serve as antenna E1 of FIG. 2. This feature provides a more efficient use of spring 29.

FIG. 1B illustrates a side view of the sensor assembly 8 of FIG. 1A when it is separate from frame 44 and before being inserted into cavity 24. FIG. 1C illustrates a front view of the sensor assembly 8 of FIG. 1B. Similar symbols and numerals in FIGS. 1A, 1B, 1C, 2, 3a, 3b and 3c indicate similar items or functions.

Advantageously, sensor assembly 8 of FIG. 1A is not firmly attached to any of the walls of cavity 24. For example, spring 29 touches wall 22a without being firmly attached to it. Sensor assembly 8 of each of FIG. 1C includes a group of 4 resilient legs 47 that are evenly distributed each 90 degree angular interval around its circumference 48. Each leg 47 is formed of a flexible material to form an arc-shaped spring. When sensor assembly 8 of FIG. 1B is still not installed in cavity 24 of FIG. 1A, a curved portion 47a of each leg 47 of FIG. 1B is tangent to circumference 48 of FIG. 1C having a center axis 49 and a diameter D1. Diameter D1 is larger than diameter D2 of cavity 24 of FIG. 1A, when sensor assembly 8 of FIG. 1B is still not installed in cavity 24 of FIG. 1A.

Advantageously, during installation, sensor assembly 8 of FIG. 1B is inserted into cavity 24 of FIG. 1A merely by a manual sliding push. Consequently, flexible legs 47 of FIG. 1B are flexed such that distance D1 of FIG. 1C contracts, in a manner not shown, and becomes equal to distance D2 of FIG. 1A.

Axis 49 of FIG. 1B also represents a direction of displacement of sensor 28a, for example. When sensor assembly 8 is installed inside cavity 24, each of flexible legs 47 of FIG. 1B produces a radial force, not shown, having a component in a direction perpendicular to a direction of axis 49 of FIG. 1B.

Advantageously, flexible legs 47 are capable of, advantageously, hindering sensor system 8 of FIG. 1A from falling out of or separating from cavity 24 when deadbolt 16 is in the unlock position. As indicated before, flexible legs 47 of FIG. 1B enable insertion of sensor assembly 8, during installation into cavity 24 of FIG. 1A. Thus, as explained before, installing sensor assembly 8 in cavity 24 is simply done by merely pushing it into cavity 24 that can be accomplished by substantially untrained user.

FIG. 4 illustrates a block diagram of a communication network 300 for communicating the status of deadbolt 16 of FIG. 1A to a user, not shown, via a cell phone 301 of FIG. 4. Similar symbols and numerals in FIGS. 1A, 1B, 1C, 2, 3a, 3b, 3c and 4 indicate similar items or functions.

For obtaining status information of deadbolt 16 of FIG. 1A, the user activates a cell-phone App in cell phone 301 of FIG. 4. Accordingly, cell phone 301 makes a phone call to a so called internet cloud 302 through a subscribed cell-phone service such as Skype or Google. The phone call will typically be transmitted over a 3G network or a Long-Term Evolution network (4G LTE) wireless communication network 303.

A Cell-Phone service provider creates an Internet Protocol (IP) packet or packets 304, in a well-known manner. IP, as the primary protocol in the Internet layer of the Internet protocol suite, has the task of delivering packets 304 from the source host to the destination host based on the IP addresses in the packet headers. IP packet 304 is routed, using a correct media access control (MAC) address, not shown, that is a unique identifier assigned to a targeted gateway 305 in, for example, a user's home. Gateway 305 contains a ZigBee router. This router utilizes the well-known ZigBee specification protocol used to create wireless personal area network (WPAN) for small low power wireless communication devices.

A subnetwork, or subnet address, forming a subdivision the IP address, is used to get the corresponding packet 304 to targeted deadbolt system 8 via BLE-ZigBee bridge device 306 that is paired with deadbolt system 8 forming an end point device. Gateway 305 translates received IP packet 304 so that it can be routed to BLE-ZigBee bridge device 306 installed in the user's home using the corresponding subnet address. Thus, the translated packet in gateway 305 is sent to BLE-ZigBee bridge device 306 using ZigBee wireless protocol utilizing 2.4 GHZ carrier frequency with 16 channels. The data in the received packet 304 specify that deadbolt sensor system 8 is to be queried. ZigBee bridge device 306 contains updated information on deadbolt sensor system 8 that is attached to it.

SOC U1 of FIG. 2 is mostly in a low-power mode and periodically wakes up to check the status of deadbolt 16 of FIG. 1A and send that information to BLE-ZigBee bridge device 306 of FIG. 4 using the BLE protocol, as mentioned before.

BLE-ZigBee bridge device 306 then retains the latest status of the deadbolt 16 of FIG. 1A. Upon user initiated command via the cell-Phone App in cell phone 301 of of FIG. 4, the latest updated status of the deadbolt 16 of FIG. 1A is then of of FIG. 4, the latest updated status of deadbolt 16 of FIG. 1A is then sent back to cell phone 301 of FIG. 4 using the same MAC addressing scheme. Thus, advantageously, the latest status of deadbolt 16 of FIG. 1A can be communicated to cell phone 301 of FIG. 4 situated virtually anywhere in the world.

Because SOC U1 of FIG. 2 is operated from small coin battery B1, its power consumption should be, preferably, kept low. Therefore, the range of the BLE wireless signal between antenna E1 of FIG. 1A and an antenna, not shown, of BLE-ZigBee bridge device 306 of FIG. 4 is typically limited to 50′ or less. In many cases, it can't transmit through walls. In contrast, BLE-ZigBee bridge device 306 can be powered from a conventional mains line voltage VMAIN that in the United States is 110V. Therefore, BLE-ZigBee bridge device 306 does not have the power dissipation constraints of SOC U1 of FIG. 2.

Advantageously, the use of the BLE-ZigBee bridge device 306 of FIG. 4 allows for extending the communication range with Gateway 305 by the use of a built-in transceiver, not shown, in BLE-ZigBee bridge device 306. The result is that the communication range between BLE-ZigBee bridge device 306 and the router of Gateway 305 is 100′ minimum with the capability of transmitting through walls.

An optional security tablet 310 may act as a home security controller. Tablet 310 may employ either BLE protocol or ZigBee protocol for communicating with BLE-ZigBee bridge device 306. If tablet 310 employs the ZigBee protocol, the communication range between BLE-ZigBee bridge device 306 and tablet 310 is also 100′ minimum with the capability to transmit through walls.

FIG. 5 illustrates a block diagram of a home-automation network 400 forming an expansion of communication network 300 of FIG. 4 for communicating with several sensors including deadbolt sensor system 8 of FIG. 4. Similar symbols and numerals in FIGS. 1A, 1B, 1C, 2, 3a, 3b, 3c, 4 and 5 indicate similar items or functions.

BLE-ZigBee bridge device 306 of FIG. 5 creates a piconet that includes deadbolt sensor system 8 and a similar deadbolt sensor system 88 that may be attached to it with BLE-ZigBee bridge device 306 as a master. At any given time, data can be transferred between BLE-ZigBee bridge device 306, as the master, and any of deadbolt sensor systems 8 and 88, as slave devices. As master, BLE-ZigBee bridge device 306 can choose which slave device to address.

Each deadbolt sensor systems 8 and 88 is typically in a low-power, sleep state and is periodically woken up by an internal timer of the corresponding SOC U1 of FIG. 1A that is set for a prescribed cycle by BLE-ZigBee bridge device 306.

BLE-ZigBee bridge device 306 retains information of when each of deadbolt sensor systems 8 and 88 wakes up and establishes communications with it that includes exchange of data. BLE-ZigBee bridge device 306 then resynchronizes the wake up time with each of deadbolt sensor systems 8 and 88, sets the period of time to re-wake up, initiates the command for the corresponding deadbolt sensor systems 8 or 88 to start its internal wake-up timer in the corresponding SOC U1 of FIG. 1A, and then commands the corresponding deadbolt sensor systems 8 or 88 of FIG. 5 to go into its low power sleep state.

If a new deadbolt sensor system, not shown, similar to deadbolt sensor systems 8 is added, the new deadbolt sensor system and BLE-ZigBee bridge device 306 undergo a so-called bonding process whereby the two devices are paired. This process is triggered either by a specific a user command to generate a bond, referred to as dedicated bonding, or it is triggered automatically when initially installed into service and the identity of a device is required for security purposes, referred to as general bonding. The Bluetooth protocol with deadbolt sensor systems 8 and 88 implements confidentiality, authentication, and key derivation with custom algorithms based on the SAFER+ block cipher.

A communication network 300′ of FIG. 5 is similar to communication network 300 having elements that are, each, referred to by similar symbols and numerals as in network 300 except for a prime symbol, “′”, that is appended to the corresponding element reference in network 300′. A resulting combined network topology of networks 300 and 300′ is referred to as a star network. This means that BLE-ZigBee bridge device 306 and a BLE-ZigBee bridge device 306′, for example, communicate with the router of Gateway 305 but not with each other.

1. A deadbolt sensor assembly, comprising:
a sensor capable to be disposed in a cavity formed in a frame of a door for sensing a deadbolt position to generate an output signal that is indicative when said deadbolt position is in said cavity in a lock position and when said deadbolt position is outside said cavity in an unlock position;
a wireless transmitter responsive to said sensor output signal and capable of being disposed in said cavity for transmitting a first wireless signal containing information derived from said output signal; and
a battery for energizing said wireless transmitter and said sensor, wherein said battery, said transmitter and said sensor are mechanically coupled together and are capable of being displaced together in said cavity in accordance with said deadbolt position.

2. (canceled)

3. A deadbolt sensor assembly according to claim 1, further comprising:
a bridge device responsive to said first wireless signal containing information related to said deadbolt position and conforming to a first protocol for periodically storing said deadbolt position containing information, said bridge device being additionally responsive to a second wireless signal conforming to a second protocol containing a request for said stored information for transmitting said stored information using a third wireless signal at a power level that is higher than a power level of said first wireless signal.

4. A deadbolt sensor assembly according to claim 3, wherein said first wireless signal conforms to a BLE protocol and said second wireless signal conforms to a ZigBee protocol.

5. A deadbolt sensor assembly according to claim 1, further comprising:
a spring capable of being disposed in said cavity for enabling displacement of said sensor in accordance with said deadbolt position; and
a resilient member mechanically coupled to said sensor for applying a force having a component in a direction perpendicular to a direction of said sensor displacement, said resilient member being capable of hindering said sensor, said spring, said wireless transmitter and said battery from falling out of said cavity when said deadbolt position is in said unlock position and of enabling insertion of said sensor, said spring, said wireless transmitter and said battery into said cavity, during installation, in a manner to avoid a need for fastening any of said sensor, said spring, said wireless transmitter and said battery to any wall of said cavity.

6. A deadbolt sensor assembly according to claim 5 wherein said resilient member comprises an arc-shaped spring.

7. A deadbolt sensor assembly according to claim 1, wherein said sensor periodically sensing said deadbolt position, during a first portion of a period, to generate an output signal indicating when said deadbolt position is in said cavity in a lock position and when said deadbolt position is outside said cavity in an unlock position, said sensor being responsive to a periodic signal for decreasing a current that discharges said battery during a second portion of said period when said deadbolt position sensing is disabled.

8. A deadbolt sensor assembly according to claim 7 wherein said sensor comprises one of a plunger switch and a light emitting diode and a transistor responsive to said periodic signal for coupling a supply voltage produced in said battery to said one of said plunger switch and said light emitting diode, during said first portion of said period, when said deadbolt position sensing is enabled and for decoupling said supply voltage from said one of said plunger switch and said light emitting diode, during said second portion of said period, when said deadbolt position sensing is disabled in a manner to provide for the current decrease.

9. A deadbolt sensor assembly according to claim 1, further comprising:
a spring mechanically coupled to at least one of said sensor and said wireless transmitter and being capable of being disposed in said cavity for applying a force when flexed to displace said at least one of said sensor and said wireless transmitter, said spring being electrically coupled to said wireless transmitter to form an antenna therefor.

10. A deadbolt sensor assembly according to claim 9, wherein said spring is capable of providing mechanical adaptability associated with at least one of a deadbolt length, a deadbolt travel distance, a length of said cavity and a dimension of a gap between said door and said frame.
